(19) United States
(12) Patent Application Publication
(10) Pub. No.: US 2013/0112773 A1
(43) Pub. Date: May 9, 2013

(54) COMPRESSED AIR-DRIVEN FOAM GENERATOR SYSTEM IN A BACKPACK FORM FACTOR

(71) Applicants: Dennis E. Smagac, Boulder, CO (US); Jonathan Lee Crenshaw, Piedmont, AL (US)

(72) Inventors: Dennis E. Smagac, Boulder, CO (US); Jonathan Lee Crenshaw, Piedmont, AL (US)

(73) Assignee: Intelgard, Inc., Broomfield, CO (US)

(21) Appl. No.: 13/288,820

(22) Filed: Nov. 3, 2011

(51) Int. Cl. B05B 9/08; B05B 7/04; B67D 7/78

(52) U.S. Cl. 239/152; 222/145.1; 239/398

(57) ABSTRACT

The foam generator apparatus includes a pair of collapsible bladders for storing a unitary or binary fluid/foam concentrate mixture and an air bottle forming a source of pressurized gas. These elements are mounted on a chassis which has a proportioning pump, mounted on the chassis, connected to the air bottle, and powered by the pressurized gas, for producing a flow of the unitary or binary fluid/foam concentrate mixture from the pair of collapsible bladders to an output port, wherein the chassis includes two sides pivotally attached to a backplate and operable to form an enclosure around the pair of collapsible bladders. An air-injection apparatus is connected to the output port of the pump to mix a controllable volume of pressurized gas into the fluid/foam concentrate mixture received from the pump to create a foam.

### FIELD OF THE INVENTION

This invention relates to a foam generation apparatus and, in particular, to an apparatus for generating and delivering foam using a compressed air-powered backpack form factor foam generator system.

### BACKGROUND

There are a number of applications where there is a need to generate a foam-based product. These applications include, but are not limited to: fire fighting; hazardous materials remediation; cleaning/sanitization; and decontamination of apparatus, buildings, and people.

There is no practical, compact form factor, delivery system for foaming formulations for these types of applications. The process of decontaminating equipment and/or a site is typically effected using large size, fossil-fuel powered, power wash generators. The decontamination product that is delivered is typically a caustic, sometimes heated, liquid which is applied to the surface to be decontaminated. These units are bulky and the fluid that is delivered fails to adhere to the surfaces to which it is applied if the surfaces are vertically oriented.

It is also a problem in the field of fire fighting to provide a sufficient volume and quality of fire fighting material to suppress a fire. The traditional fire fighting material used for this purpose is water, which has the undesirable side effect of causing a significant amount of water damage to the real property in and around the area in which the fire is engaged. In fact, in many situations, the water damage to the real property is significantly in excess of the fire damage to the real property. An alternative fire fighting material in use is fire suppressant foam. However, the difficulty with fire suppressant foam is that the typical materials used for this purpose require complicated mixing and pumping apparatus and still produce a significant amount of water damage due to the relatively high water content of the foam.

In a typical application, the availability of a significant water supply renders water the desired choice as a fire fighting material, since the fire suppressant foam itself requires a significant amount of water. In addition, fire suppressant foam requires complicated generation and delivery apparatus, thereby rendering it impractical for use except in certain selected applications, such as airport fire fighting applications where the use of water is ineffective in controlling the magnitude and extent of a fuel fire.

One departure from the fire fighting prior art is taught by U.S. Pat. Nos. 5,623,995 and 6,155,351, which disclose a fire suppressant foam generation and application apparatus that produces a low-moisture-content fire suppressant foam for use in fire fighting applications. The reduction in the water content of the fire suppressant foam is accomplished by the use of pressurized gas in place of water along with a foam concentrate agitation apparatus to agitate the foam concentrate/water mixture to create a fire suppressant foam. A pressurized gas-operated pump can be used to actively draw the water/foam concentrate mixture from a supply tank and supply it under pressure to the foam concentrate agitation apparatus and outlet line. The apparatus is a molded tank that has a cut out for the placement of the cylinder that contains the pressurized gas. This apparatus has the disadvantages of cost, weight, and size limitations since the use of a rigid molded tank adds weight to the product and eliminates the option of custom sizing the volume of product that is stored therein.

In current and emerging foaming technologies, it is desirable to have the ability to store, mix, and apply binary formulations. In these applications, proportional, controlled, and accurate mixing of formulary binary components is crucial to effective application of the binary formulas in their stated mission roles and performance specifications.

### SOLUTION

The above-described problems are solved and a technical advance achieved in the field by the Compressed Air-Driven Foam Generation Apparatus in a Backpack Form Factor of the present invention (termed “foam generator system” herein). This apparatus makes use of a commercially available low-moisture-content foam mixture in conjunction with a novel foam generation and application apparatus to improve on the backpack concepts taught in the above-noted U.S. Pat. Nos. 5,623,995 and 6,155,351. This apparatus is simple in structure and operation and makes use of a pressurized gas to create the binary or unitary formula's fluid/foam mixture (or fluid/foam+additive mixture), propel it through the delivery apparatus, and power an auxiliary pump to increase the delivery pressure of the generated foam. This apparatus is lightweight in construction, simple in architecture, and can be disassembled into its component parts, folded, and stored in minimal space. The use of one or more bladders to hold the fluid/foam concentrate (and optional additives) enables the user to custom select the volume of material staged in the unit, load different formula ingredients in separate bladders, proportionally mix separate ingredients, and to remove and replace a bladder in the event maintenance is required or different pre-packaged formulas are needed for varied mission conditions. This design optimizes for low weight, flexibility, and low cost and multi-mission applications.

The foam generator apparatus disclosed herein includes a pair of collapsible bladders for storing a fluid/foam concentrate mixture either as a single unitary formula or as a binary formula with different ingredients (one of water and foam concentrate) in each bladder and an air bottle forming a source of pressurized gas. These elements are mounted on a chassis which has a pump mounted on the chassis, connected to the air bottle, and powered by the pressurized gas, for mixing binary formulas in a controlled, proportional method, and producing a flow of the fluid/foam concentrate mixture from the pair of collapsible bladders to an output port, wherein the chassis attaches to a backplate which includes two sides pivotally attached to the backplate and operable to form an enclosure around the pair of collapsible bladders. An air injection apparatus is connected to the output port of the pump to mix a controllable volume of pressurized gas into the fluid/foam concentrate mixture received from the pump to create a foam.

### BRIEF DESCRIPTION OF THE DRAWINGS

FIGS. 1A, 1B, and 1C illustrate front, rear, and bottom views of the present foam generator system;

FIGS. 2A and 2B illustrate, in block diagram form, the overall architecture of two embodiments of the present foam generator system;

FIGS. 3A and 3B illustrate back and rear plan views, respectively, of the pack components of the present foam generator system;

FIG. 4 illustrates a perspective view of the chassis assembly of the present foam generator system;

FIG. 5 illustrates a front view of the components of the present foam generator system as installed in the pack chassis; and

FIG. 6 illustrates an applicator wand for use in the present foam generator system.

### DETAILED DESCRIPTION

### Theory of Operation

Foam is produced from a combination of a fluid and a foam concentrate (unitary or binary or other multiple component formulas) and a propellant which functions to both agitate the fluid/foam concentrate mixture to create the expanded foam and to deliver it through the application apparatus. The propellant of choice in this system is a compressed gas which produces a dry foam mixture. Furthermore, the use of the pressurized gas eliminates the need for a large complex pumping apparatus to pump an incompressible fluid, such as water, that has been used in the past to agitate and supply the foam mixture to the spray nozzles. A simple hydraulic or pressurized gas-operated pump can be used to actively draw the fluid/foam concentrate mixture, where the pump is capable of proportional mixing of bladder contents of either unitary or binary foam concentrate formulas, from a supply tank and supply it under pressure to the outlet of the pump where it is mixed with and agitated by the pressurized gas to create the resultant foam. It is typical for one bladder to store the fluid, such as water, and the other bladder to store a foam concentrate. Alternatively, the foam concentrate is pre-mixed with the water and stored in the system as the fluid/foam concentrate and other additives may be added to this fluid/foam concentrate mixture in order to further condition the foam or to use the foam as a carrier of the additive as it is applied to an object.

### System Architecture

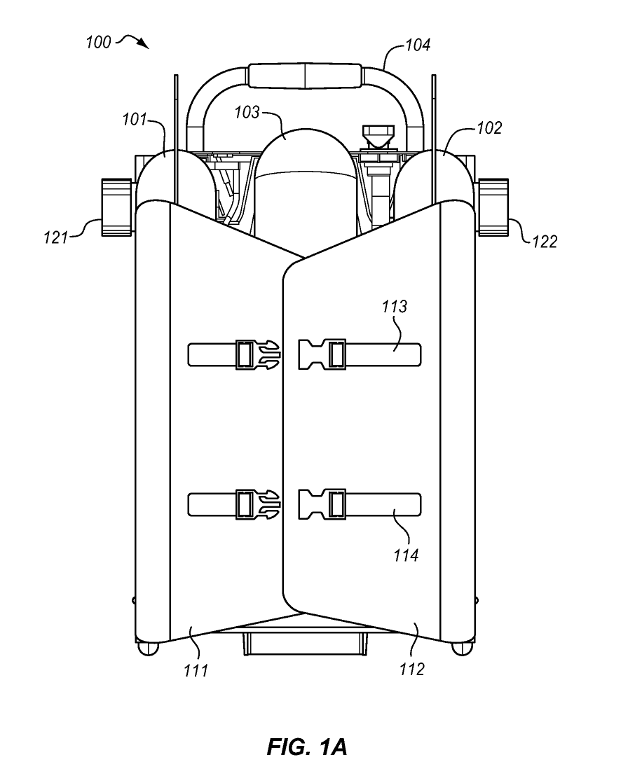

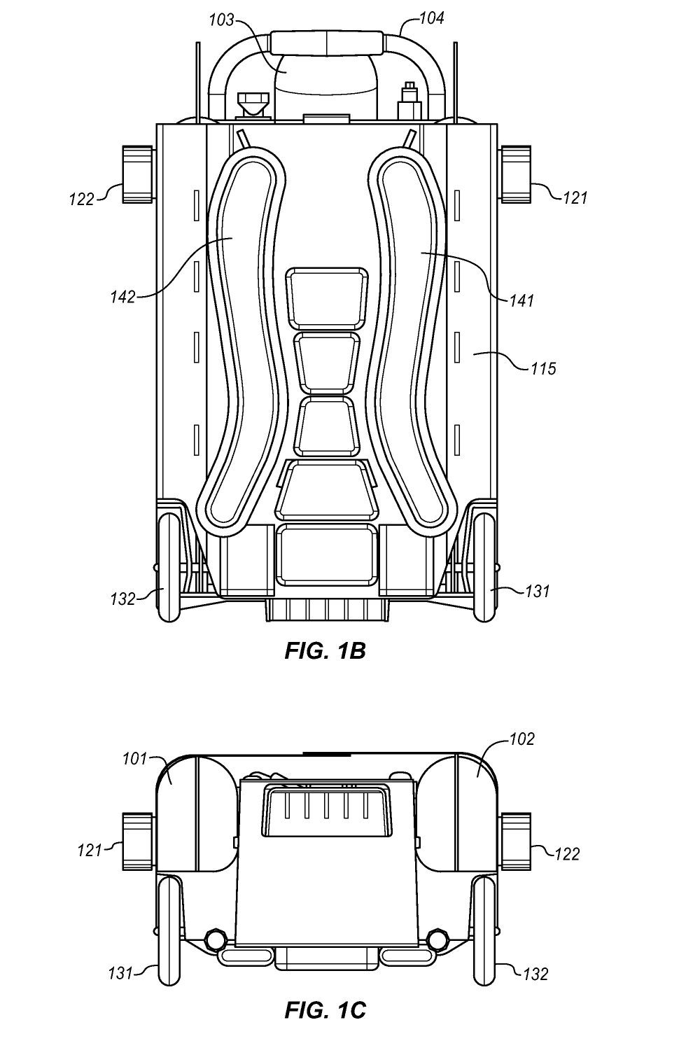

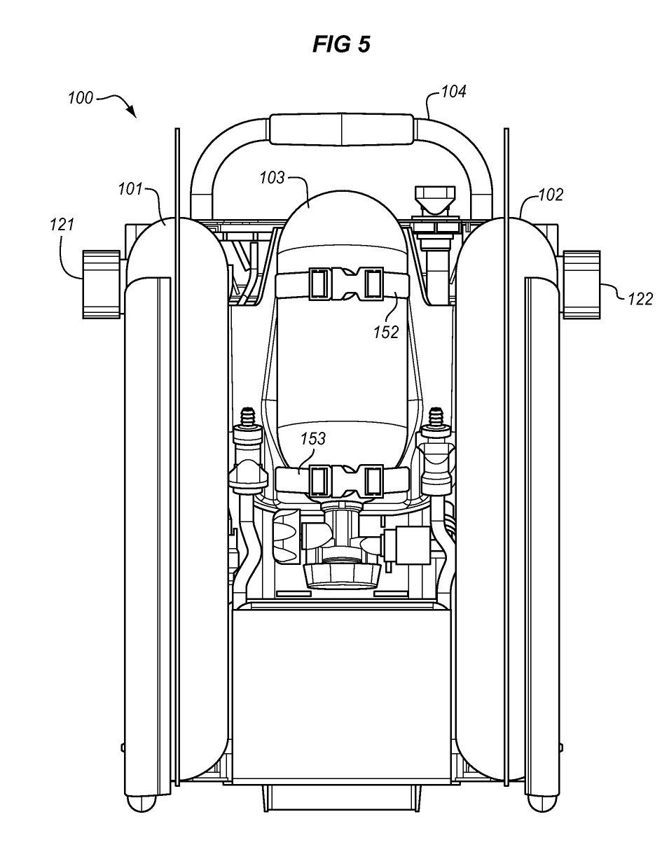

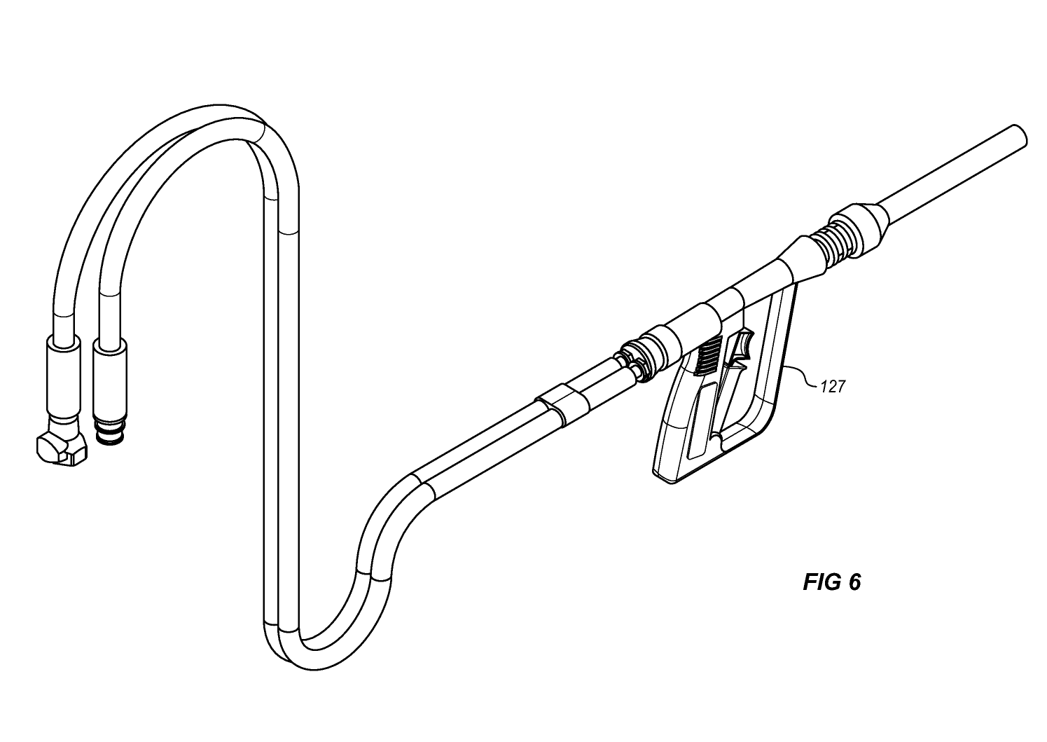

FIGS. 1A, 1B, and 1C illustrate front, rear, and bottom views of the present foam generator system 100; and FIG. 5 illustrates a front view of the components of the present foam generator system 100 as installed in the pack chassis. In the illustrated embodiment, the fluid/foam concentrate mixture is stored in one or more collapsible bladders 101, 102 in premixed form in proportions dictated by the manufacturer of the foam concentrate or as separate binary components, with the fluid and the foam concentrate in separate bladders with proportional mixing accomplished by metered feed from the bladders through the pump(s). The foam concentrate typically is diluted with a fluid, such as water, to produce the fluid/foam concentrate mixture, which expands into the resultant foam product when agitated by a propellant and delivered through properly dimensioned pipes or hoses. In addition, additives optionally can be added from other bladders thereby to use the foam as a carrier of the additive to the object which is to be treated with the foam. In the foam generator system 100, the propellant consists of air that is stored in a highly pressurized condition in an air tank 103 which is interconnected to the pump 401 and air injector 214.

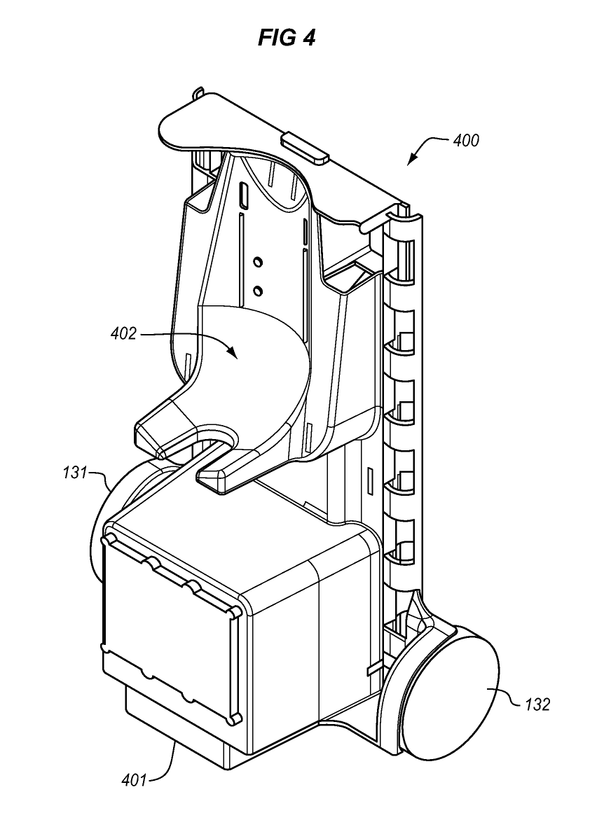

The pair of collapsible bladders 101, 102 and air bottle 103 are mounted on a chassis 400, as shown in FIG. 4, which has an air-operated diaphragm pump 401 (such as a dual diaphragm pump), also mounted on the chassis 400, connected to the air bottle 103, and powered by the pressurized gas, for producing a flow of the fluid and foam concentrate mixture from the pair of collapsible bladders 101, 102 to an output port, wherein the chassis 400 attaches to a backplate 115 which includes two sides 111, 112 pivotally attached to the backplate 115 and operable to form an enclosure around the pair of collapsible bladders 101, 102.

### System Operational Block Diagram

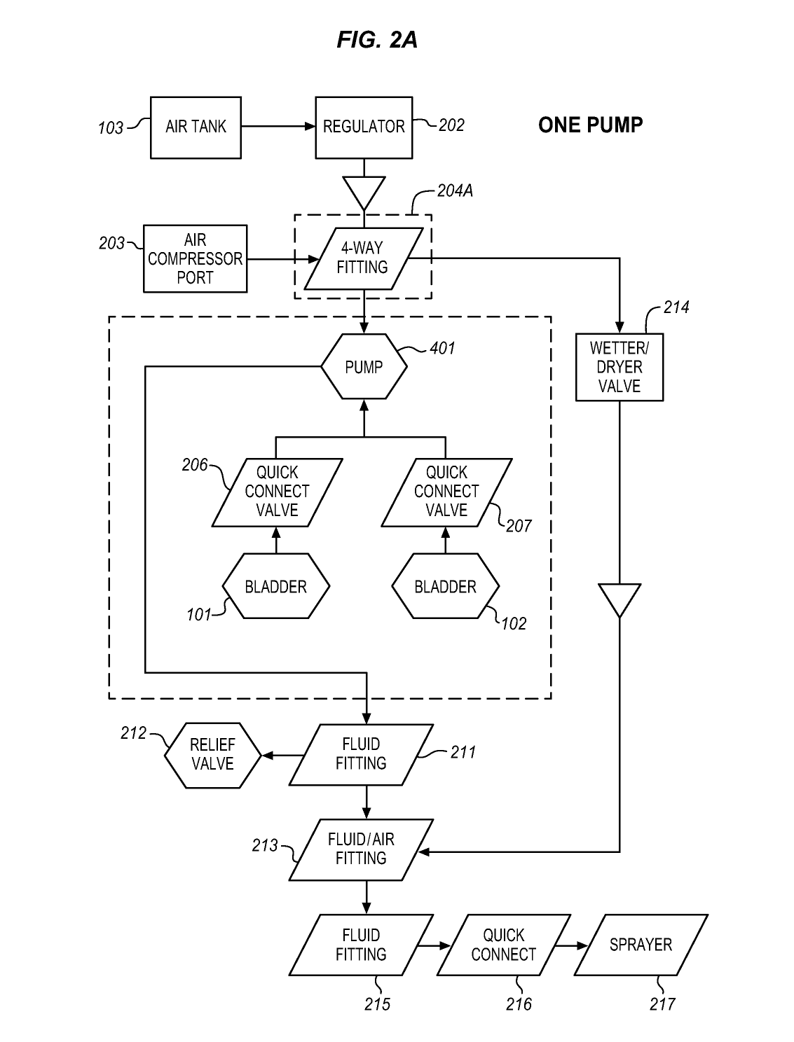

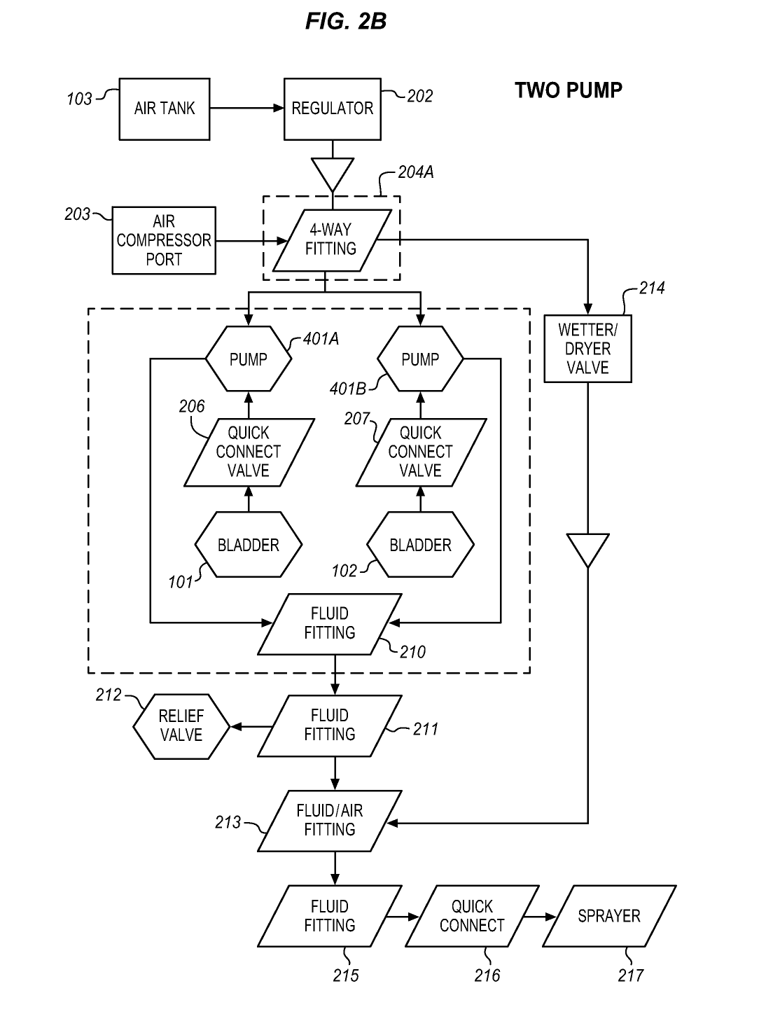

FIGS. 2A and 2B illustrate, in block diagram form, the overall architecture of two embodiments of the present foam generator system 100, a single pump system and a dual pump system, respectively. There are two potential sources of compressed air: air tank 103 and air compressor port 203. The compressed air tank 103 is connected as a source of compressed air to four-way fitting 204A (or five-way fitting 204B) via a pressure regulator 202, while air compressor port 203 is directly connected to four-way fitting 204A (or five-way fitting 204B). There are two sets of outputs from four-way fitting 204A (or five-way fitting 204B): air injector 214 and air-operated pump 401 (or pumps 401A, 401B). In FIG. 2A, pump 401 is connected via quick connect valves 206, 207 to the respective collapsible bladders 101, 102 which store the fluid/foam concentrate mixture. In FIG. 2B, pumps 401A, 401B are connected via quick connect valves 206, 207 to the respective collapsible bladders 101, 102 which store the fluid/foam concentrate mixture.

The pressurized air operates the air-operated diaphragm pump 401 (or pumps 401A, 401B) to create a flow of the fluid/foam concentrate mixture from the bladders 101, 102 to a fluid fitting 211 (provided with a relief valve 212) which is connected to fluid/air fitting 213. Pressurized air also is drawn from four-way fitting 204A (or five-way fitting 204B) and applied to air injector 214 which enables the user to regulate the volume of pressurized air injected into the flow of fluid/foam concentrate mixture at fluid/air fitting 213 thereby to cause the fluid/foam concentrate mixture to expand due to the injection of the pressurized air. The result of the expansion process is the creation of foam, which is output via fluid fitting 215 to fitting 216 and into spray wand 217, where the user can control the application of the generated foam to the desired surface.

These various valves, fittings, and pipes are routed among the air bottle 103, collapsible bladders 101, 102, pump 401, and delivery wand 127 elements as shown in FIG. 5. Details of the physical orientation of all of these elements are not relevant to an understanding of the present foam generator system 100 and, therefore, are not described in detail herein.

### Backpack Unit

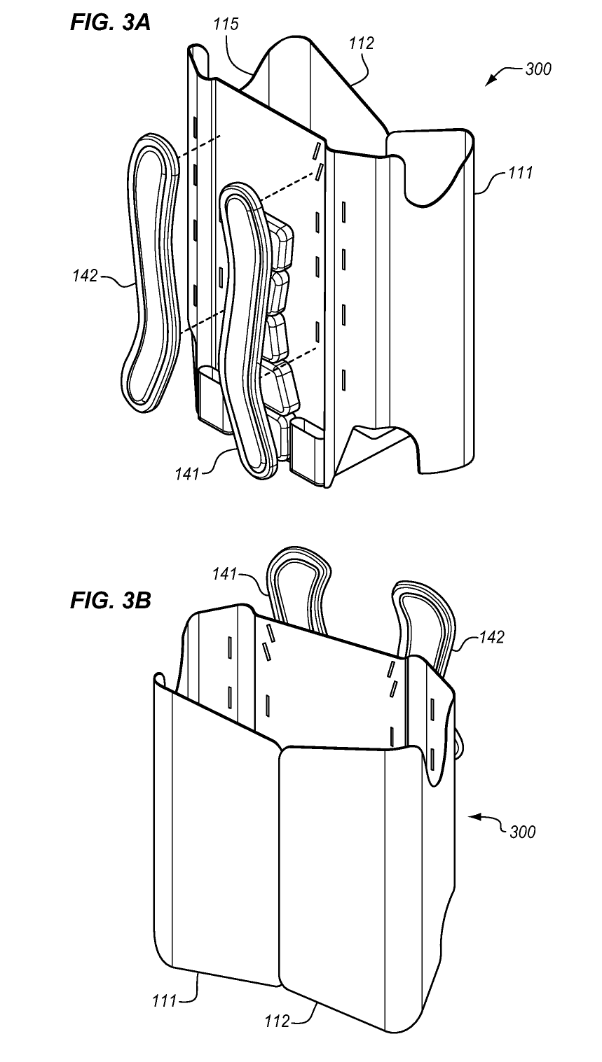

FIGS. 3A and 3B illustrate back and rear plan views, respectively, of the pack components of the present foam generator system 100. This foam generator apparatus 100 is lightweight in construction, simple in architecture, and can be disassembled into its component parts for maintenance or folded and stored in minimal space. The use of one or more bladders to hold the binary or unitary fluid/foam concentrate enables the user to custom select the volume and type of material staged in the unit, to proportionally mix binary formulas via the pump settings, and to remove and replace a bladder in the event maintenance is required. This design optimizes for low weight, flexible, low cost multi-mission applications.

A backpack architecture is used to implement the foam generator; and the pack optionally can be provided with a pair of wheels 131, 132 to facilitate transportation and storage. In addition, an optional extensible handle 104 can be provided to facilitate rolling the foam generator system 100 on its wheels 131, 132. The minimization of weight and cost is achieved through the use of collapsible bladders 101, 102 to store the foam concentrate mixture and the use of a lightweight chassis 400 that uses two pivotally connected sides 111, 112 to enclose the collapsible bladders 101, 102. Pockets (not shown) optionally are formed on the interior facing surface of the two pivotally connected sides 111, 112. For balance purposes, the pump 401 is mounted on the bottom of the chassis 400.

The backplate 115 includes one or more straps 152, 153 with buckles attached thereto, which are used to secure the chassis 400 to the backplate 115 and also the air tank 103 in place in the recess 402 formed in the chassis 400. The collapsible bladders 101, 102 each include a fill port 121, 122 with a lid to seal the opening. The fill port 121, 122 in the collapsible bladder 101, 102 is accessible via an opening formed in the top of the pivotally connected side 111, 112.

FIG. 6 illustrates an applicator wand 127 for use in the present foam generator system.

### Summary

The foam generator apparatus includes a pair of collapsible bladders for storing a unitary or binary foam concentrate mixture and an air bottle forming a source of pressurized gas. These elements are mounted on a chassis which has a pump, mounted on the chassis, connected to the air bottle, and powered by the pressurized gas, for producing a flow of the foam concentrate mixture from the pair of collapsible bladders to an output port, wherein the chassis includes two sides pivotally attached to a backplate and operable to form an enclosure around the pair of collapsible bladders.

1. An apparatus for generating foam from a foam concentrate mixture comprising:
at least one collapsible bladder for storing a fluid/foam concentrate mixture;
a source of pressurized gas;
a chassis having a pump, mounted on the chassis, connected to the source of pressurized gas, and powered by the pressurized gas, for producing a flow of the fluid/foam concentrate mixture from the at least one bladder to an output port, wherein the chassis includes two sides pivotally attached to a backplate and operable to form an enclosure around the collapsible bladder;
an air injector, connected to the output port of the pump, for mixing a controllable volume of pressurized gas into the fluid/foam concentrate mixture received from the pump to create a foam; and
a spray wand, connected to the air injector, for delivering the foam output by the air injection apparatus.

2. The foam generator apparatus of claim 1 wherein:
the source of pressurized gas is an air bottle; and
the chassis includes a shaped recess, which conforms to the size and shape of the air bottle, for receiving and retaining the air bottle.

3. The foam generator apparatus of claim 2 wherein:
the chassis is a vertically-oriented, molded structure, and the shaped recess is vertically oriented and centrally located;
the at least one collapsible bladder comprises two collapsible bladders, located one on each side of the air bottle, to store a unitary or binary fluid/foam concentrate mixture; and
the pump is mounted on the chassis below the air bottle.

4. The foam generator apparatus of claim 1 wherein the source of pressurized gas comprises:
a fitting which is connected to the pump and also connectible via a fluid conduit to an externally located source of pressurized air.

5. The foam generator apparatus of claim 1 wherein the pump comprises:
at least one air-operated diaphragm pump capable of proportional mixing of bladder contents of either unitary or binary fluid/foam concentrate formulas.

6. The foam generator apparatus of claim 1 wherein the chassis includes:
a vertically-oriented plate substantially forming one exterior surface of the foam generator apparatus; and
at least one strap attached to the vertically-oriented plate to enable a user to carry the foam generator apparatus as a backpack.

7. The foam generator apparatus of claim 1 wherein the chassis further comprises:
at least one strap, which extends from one of the two pivotally attached sides to the other pivotally attached side, and, when secured, serves to secure the two pivotally attached sides to form an enclosure around the collapsible bladder.

8. The foam generator apparatus of claim 1, further comprising:
a pair of wheels, connected to the chassis and located on the bottom of the chassis, for enabling the foam generator apparatus to be rolled along on a substantially horizontal surface.

9. The foam generator apparatus of claim 1 wherein the chassis further comprises:
a first pocket, attached to a first of the two pivotally attached sides, for receiving the collapsible bladder.

10. The foam generator apparatus of claim 9 wherein the chassis further comprises:
a second pocket, attached to a second of the two pivotally attached sides, for receiving a second collapsible bladder.

11. An apparatus for generating foam from a unitary or binary foam concentrate mixture comprising:
a pair of collapsible bladders for storing a unitary or binary fluid/foam concentrate mixture;
an air bottle forming a source of pressurized gas;
a chassis having a pump, mounted on the chassis, connected to the air bottle, and powered by the pressurized gas, for producing a proportioned flow of the unitary or binary fluid/foam concentrate mixture from each of the pair of collapsible bladders to an output port, wherein the chassis includes two sides pivotally attached to a backplate and operable to form an enclosure around the pair of collapsible bladders; and
an air injector, connected to the output port of the pump, for mixing a controllable volume of pressurized gas into the fluid/foam concentrate mixture received from the pump to create a foam.

12. The foam generator apparatus of claim 11 wherein:
the chassis includes a shaped recess, which conforms to the size and shape of the air bottle, for receiving and retaining the air bottle.

13. The foam generator apparatus of claim 11 wherein the chassis further comprises:
a pair of pockets, each attached to a respective one of the two pivotally attached sides, for receiving a corresponding one of the pair of the collapsible bladders.

14. The foam generator apparatus of claim 11 wherein the source of pressurized gas comprises:
a fitting which is connected to the pump and also connectible via a fluid conduit to an externally located source of pressurized air.

15. The foam generator apparatus of claim 11 wherein the pump comprises:
at least one air-operated diaphragm pump capable of proportional mixing of bladder contents of either unitary or binary fluid/foam concentrate formulas.

16. The foam generator apparatus of claim 11 wherein the chassis includes:
a vertically-oriented plate substantially forming one exterior surface of the foam generator apparatus; and
at least one strap attached to the vertically-oriented plate to enable a user to carry the foam generator apparatus as a backpack.

17. The foam generator apparatus of claim 11 wherein the chassis further comprises:
at least one strap, which extends from one of the two pivotally attached sides to the other pivotally attached side, and, when secured, serves to secure the two pivotally attached sides to form an enclosure around the collapsible bladder.

18. The foam generator apparatus of claim 11, further comprising:
a pair of wheels, connected to the chassis and located on the bottom of the chassis, for enabling the foam generator apparatus to be rolled along on a substantially horizontal surface.

19. An apparatus for generating foam from a foam concentrate mixture comprising:
at least one collapsible bladder for storing a fluid/foam concentrate mixture;
a source of pressurized gas;
a pump, powered by the pressurized gas, for producing a proportional flow of the foam concentrate mixture from each of the at least one bladder to an output;
an air injector, connected to the output port of the pump, for mixing a controllable volume of pressurized gas into the fluid/foam concentrate mixture received from the pump to create a foam; and
a spray wand, connected to the air injector, for delivering the foam output by the air injection apparatus.

20. The foam generator apparatus of claim 19, further comprising:
wherein the source of pressurized gas is an air bottle; and
wherein the pump comprises at least one air-operated diaphragm pump capable of proportional mixing of bladder contents of either unitary or binary fluid/foam concentrate formulas.

21. The foam generator apparatus of claim 19, further comprising:
wherein the at least one collapsible bladder comprises two collapsible bladders, located one on each side of the air bottle, to store a unitary or binary foam concentrate mixture
